(19) United States
(12) Patent Application Publication
(10) Pub. No.: US 2007/0155555 A1
(43) Pub. Date: Jul. 5, 2007

(54) Movable guide for transmission device

(75) Inventors: Tadaaki Fukata, Osaka (JP); Masahiko Konno, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/526,508

(22) Filed: Sep. 25, 2006

(30) Foreign Application Priority Data
Dec. 19, 2005 (JP) 2005-364838

(51) Int. Cl. F16H 7/08

(52) U.S. Cl. 474/111

(57) ABSTRACT

A movable guide for a flexible, endless, traveling transmission medium such as a timing chain is formed by sandwich molding and incudes a boss for receiving a shaft on which the guide is pivotable. The boss is composed of a plurality of concentric circular ribs and a plurality of radial connecting ribs, which connect the circular ribs. The resin charging port of the mold is located in an end wall of the mold cavity near the location at which the boss is formed. One of the connecting ribs preferably extends perpendicularly toward the sliding contact surface of the guide shoe.

### CROSS-REFERENCE TO RELATED APPLICATION

This application claims priority on the basis of Japanese patent application 2005-364838, filed Dec. 19, 2005. The disclosure of Japanese application 2005-364838 is hereby incorporated by reference.

### FIELD OF THE INVENTION

This invention relates to chain transmissions for transmitting rotation from a driving sprocket to one or more driven sprockets through an endless transmission chain, and more specifically to a movable chain guide, used in conjunction with a tensioner to accommodate chain elongation, maintain appropriate chain tension, and suppress vibration and noise, in the timing chain of an automobile engine.

### BACKGROUND OF THE INVENTION

As shown in FIG. 1, a typical automobile engine is provided with a timing transmission in which a chain CH is driven by a crankshaft sprocket S1 and drives one or more camshaft sprockets S2. A movable sliding-contact guide GA, and a fixed guide GB are provided on opposite sides of the timing chain to prevent lateral vibration of the chain and also to prevent vibration of the chain in the plane of its travel. The movable guide GA is pivotable on a shaft P, which is attached to the engine E. The movable guide GA has a shoe in sliding contact with the chain, and the guide is biased toward the chain by a tensioner T. The fixed guide GB is immovably attached to the engine E by suitable means such as mounting bolts Q.

U.S. Pat. No. 6,890,277 describes a sandwich molding method by which the movable guide GA is formed by the simultaneous integral molding of a core and a skin layer from different resins having suitable properties.

The sandwich molding is performed by a molding machine 60, as shown in FIG. 8. The molding machine has two cylinders, 62 and 64, from which two kinds of resin are forced into a metal mold 68 through a nozzle 66. The resins join at the nozzle, but, In spite of the simulataneous injection the skin layer material and the core layer material, the materials remain separated, and the resin from cylinder 64 formes a core, while the resin from cylinder 62 forms a skin layer which covers the entire surface of the core.

As shown in FIGS. 5(a) and 5(b), in the conventional sandwich-molded movable guide, a boss 42 is provided in order to receive a shaft on which the guide is pivoted. As shown in FIG. 5(b), the thickness d2 of the boss, in the direction of its diameter, is small. Because of the small thickness of the boss, some flexing of the boss is permitted, and the guide can tilt on its pivot axis as shown in FIG. 7(a). The tilting of the guide permits increased lateral vibration of guide, resulting in the generation of vibration noise, and excessive wear of the inner wall of hole 41 in the boss 42. Lateral vibration of the guide can be reduced by increasing the thickness of the wall of the boss, as shown in FIGS. 6(a) and 6(b), where the boss 52 has a thickness d3, which is greater than the thickness d2 of the boss in FIGS. 5(a) and 5(b). Increasing the thickness of the boss can reduce lateral vibration, as illustrated in FIG. 7(b). However, in a sandwich-molded guide, making the thickness of the boss greater than the thickness of other parts of the guide can result in the production of voids within the wall of the boss due to shrinkage. Even though the outer appearance of the guide is unaffected, the presence of voids in the wall of the boss can result in reduction of the durability of the guide.

Furthermore, the strength and durability of the conventional sandwich molded guide can vary depending on the location of the port through which the resins are injected into the mold, and, as a result, some guides can have much greater strength and durability than other guides.

The invention addresses the above-described problems, and provides a movable guide exhibiting reduced lateral vibration, but having high strength and durability.

### SUMMARY OF THE INVENTION

The movable guide in accordance with the invention comprises a shoe having front and back sides. The front side has a sliding contact surface on which a traveling transmission medium can slide, and a shoe support provided on the back side of the shoe.

The guide is elongated in a direction along which the transmission medium travels when in sliding contact with the sliding contact surface. The shoe and shoe support comprise a core and a skin layer composed of different resins, and the core and skin layer are sandwich molded. One end of the guide in the direction of elongation includes a boss for receiving a mounting shaft on which the guide is pivotable, and the opposite end of the guide is movable in an arcuate path about an axis of rotation extending through the boss. The boss comprises a plurality of concentric circular ribs connected by a plurality of connecting ribs, at least one of which preferably extends toward the shoe and in a direction normal to the sliding contact surface of the shoe.

The guide is preferably formed by injecting resin into a mold through a resin charging port provided in an end wall of the mold cavity near the location at which the boss is formed.

Since the boss of the guide according to the invention is formed with concentric ribs, it does not have a thick wall, and therefore the decrease in durability due to the generation of voids within the boss can be avoided. The connecting ribs, however, connect the concentric ribs of the boss, reinforcing the boss and prevent excessive lateral vibration of the guide. Furthermore, the boss according to the invention has an increased surface area, and therefore, heat generated as a result of friction between an inner surface of the boss hole and the mounting shaft pin is dissipated efficiently, and deterioration of the resin due to excessive heat is suppressed. The concentric ribs have another advantage in that lubricating oil can accumulate between them. The accumulated lubricating oil can penetrate between the inner surface of the boss hole and the mounting shaft, providing improved reduction of friction.

Where one of the connecting ribs extends in a direction normal to the shoe of the guide, the boss can withstand an increased load applied to it by the transmission chain.

When the resin charging port in the mold used to produce the guide is located on an end wall of the mold cavity near the location at which the boss of the guide is formed, resin is able to flow more smoothly to the concentric ribs and to the connecting ribs, and a guide having superior durability can be produced.

### BRIEF DESCRIPTION OF THE DRAWINGS

FIG. 1 is a schematic front elevational view of the timing transmission of a DOHC internal combustion engine incorporating a movable guide in accordance with the invention;

FIG. 2(a) is an elevational view of a movable guide in accordance with a first embodiment of the invention;

FIG. 2(b) is a cross-sectional view taken on plane 2(b)-2(b) of FIG. 2(a);

FIG. 3 is an elevational view of a movable guide in accordance with a second embodiment of the invention;

FIG. 4 is an elevational view of a movable guide in accordance with a third embodiment of the invention;

FIG. 5(a) is an elevational view of a conventional movable guide;

FIG. 5(b) is a cross-sectional view taken on plane 5(b)-5(b) in FIG. 5(a);

FIG. 6(a) is an elevational view of another conventional movable guide;

FIG. 6(b) is a cross-sectional view taken on plane 6(b)-6(b) in FIG. 6(a);

FIG. 7(a) is a sectional view illustrating lateral vibration of the conventional movable guide of FIGS. 5(a) and 5(b);

FIG. 7(b) is a sectional view illustrating reduced lateral vibration in the conventional movable guide of FIGS. 6(a) and 6(b); and

FIG. 8 is a schematic view illustrating the sandwich molding process used to make the movable guides in accordance with the invention.

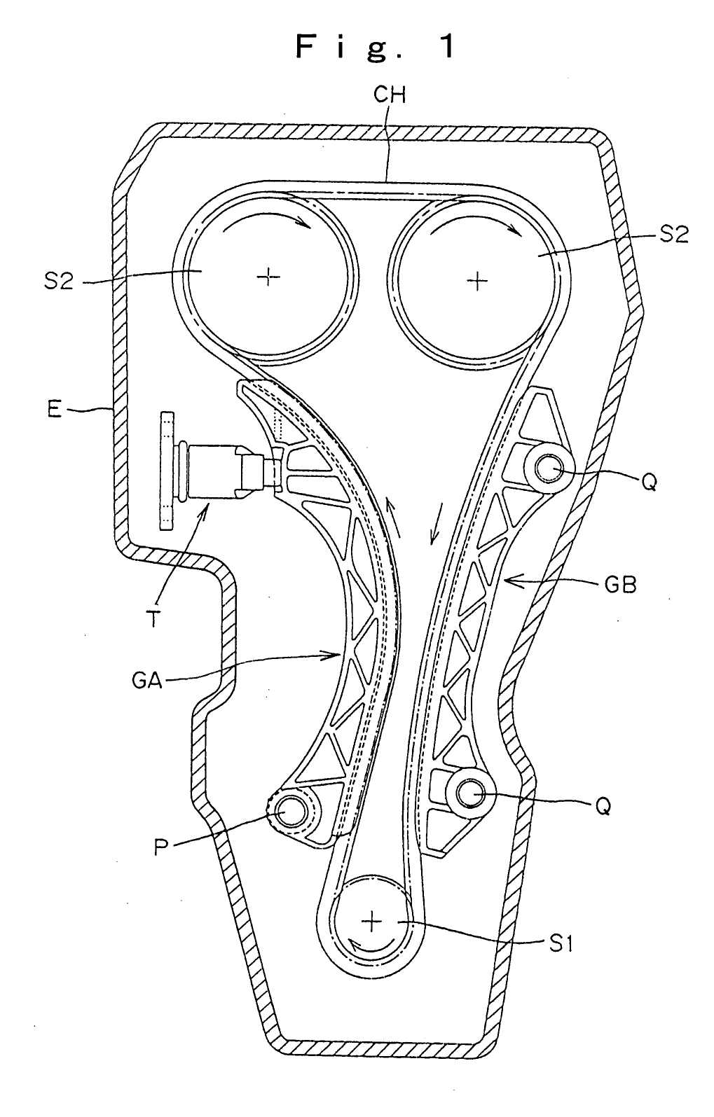

### DETAILED DESCRIPTION OF THE PREFERRED EMBODIMENTS

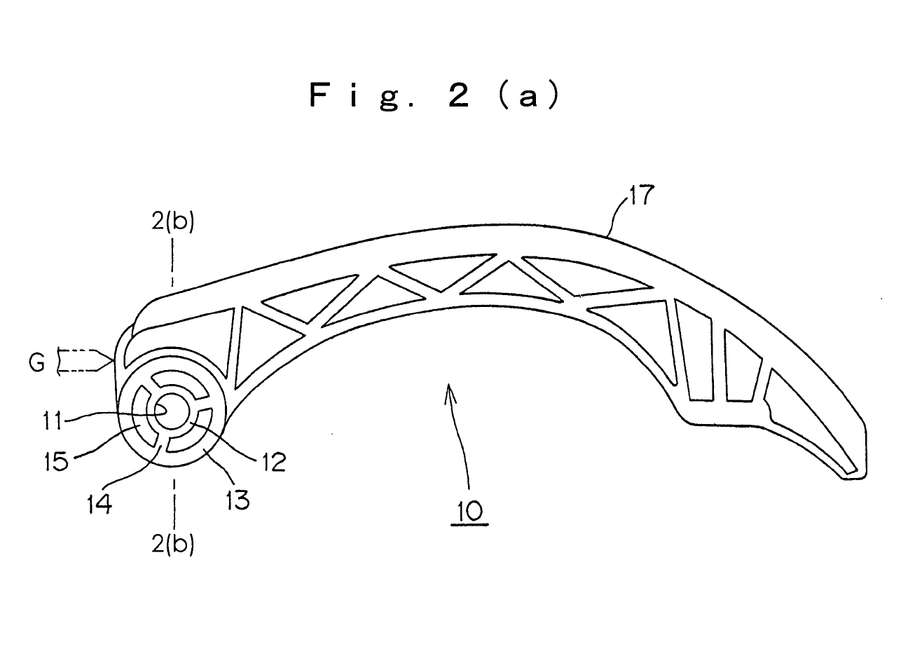

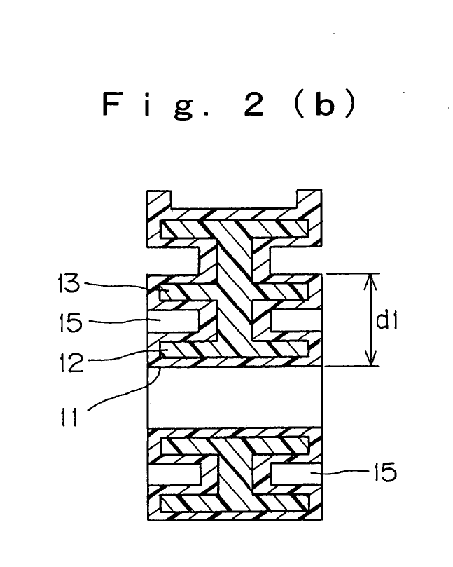

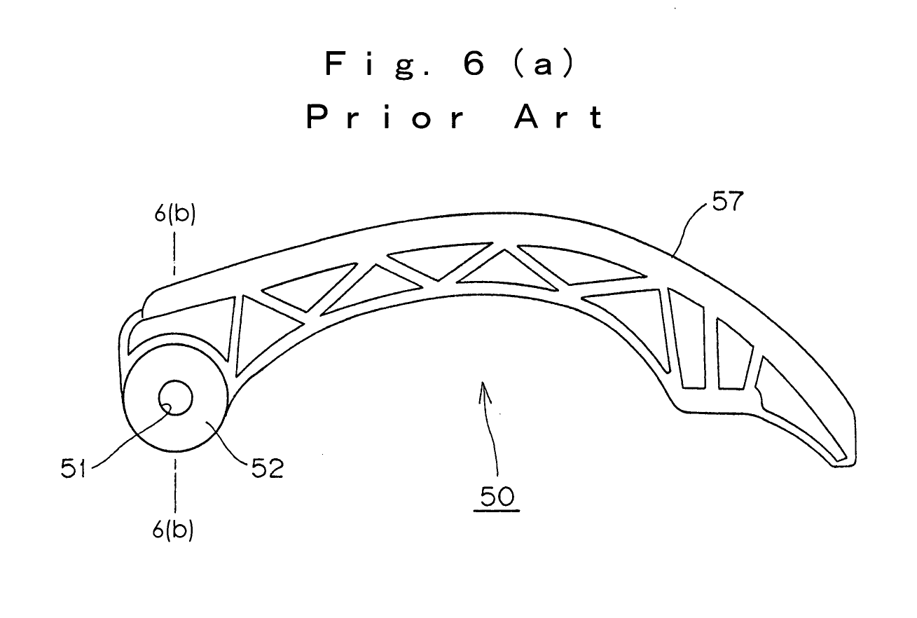

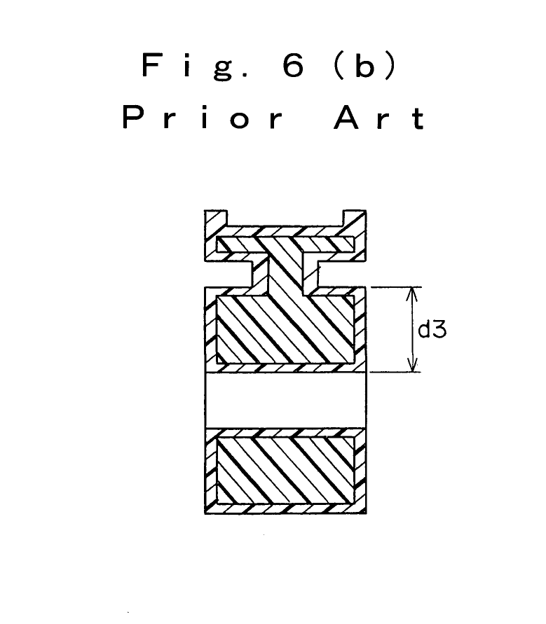

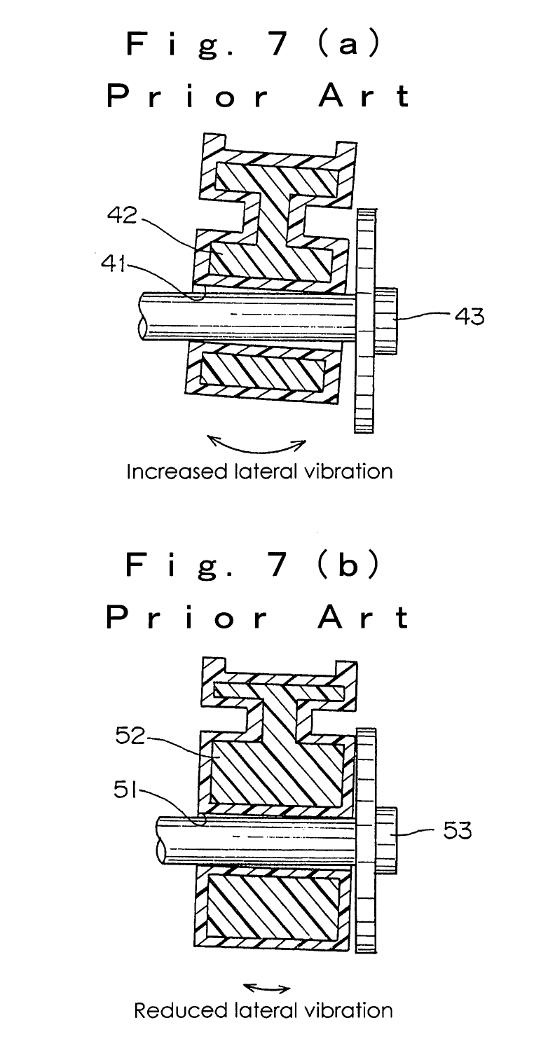

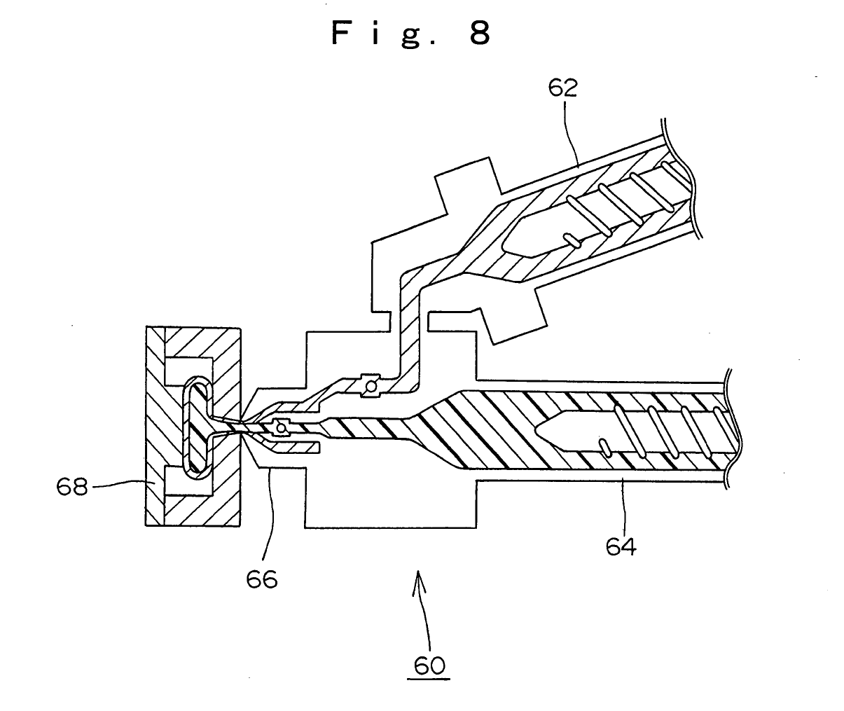

As shown in FIGS. 2(a) and 2(b), in a first embodiment of the movable sliding contact guide in accordance with the invention, a boss, with a hole 11 for receiving a mounting shaft (not shown), comprises a circular inner rib 12, a circular outer rib 13, concentric with the inner rib, and radial connecting ribs 14 extending from the inner rib ot the outer rib. As shown in FIG. 2(b), both ends of the boss have similar rib structures. The thicknesses of the circular inner rib, the circular outer rib, and the connecting ribs, are substantially uniform, and relatively small compared to the radial thickness d3 of the boss in the conventional guide shown in FIG. 6(b). Because the thicknesses of the ribs are relatively small, large temperature gradients that result in the generation of internal voids in the molding process are avoided. With the elimination of these internal voids, the strength of the movable guide is improved, and its useful life is extended. Although the number of connecting ribs 14 is not limited, it is preferred that three or four connecting ribs 14 be provided at equiangular intervals. Thus, in the embodiment shown in FIG. 2(a), three connecting ribs 14 are provided at 120° intervals. Empty, arc-shaped recesses 15 are formed between the radial connecting ribs 14 as seen in FIGS. 2(a) and 2(b). These recesses 15, which are formed in the sandwich molding process, separate the boss into inner and outer circular ribs 12 and 13 and allow the thickness of the ribs 12, 13 and 14 to be substantially uniform, while the overall thickness d1 of the boss (FIG. 2(b)) is similar to thickness d3 in FIG. 6(b), and sufficient to enable the guide to resist lateral vibration.

As a result of repeated experimentation with different positions of the resin charging port in the sandwich mold, we have discovered that, in the process of molding the above-described movable guide, the resins flow most uniformly throughout the entire guide when the resin charging port is provided in an end wall of the mold cavity near the location at which the boss is formed.

We have also determined through extensive experimentation that the strength of the boss is affected by the directions of the connecting ribs. The greatest strength against a load applied by a chain sliding on the shoe of the guide is obtained when one of the connecting ribs on each end of the boss extends toward the shoe and along a direction normal to the sliding contact surface of the shoe.

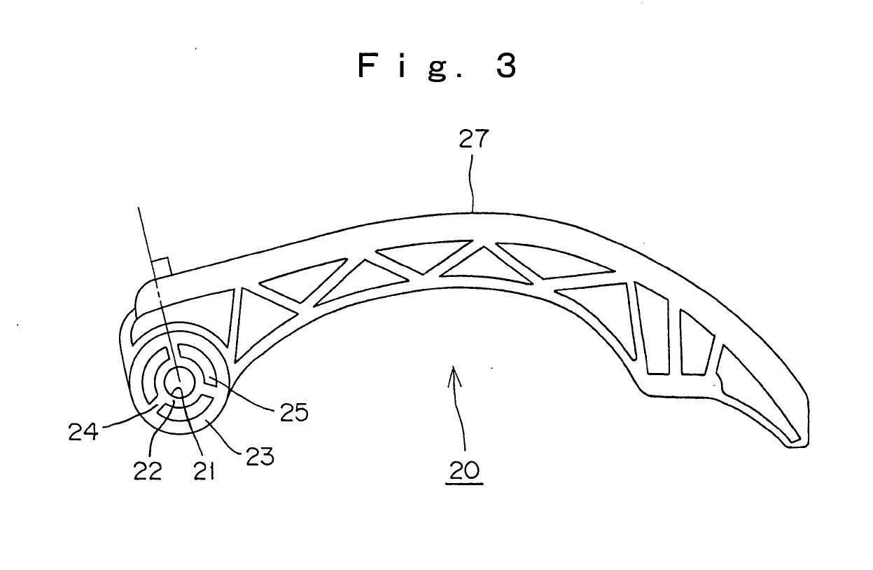

Thus, in the second embodiment, shown in FIG. 3, one of the three connecting ribs 24, which are separated by arcuate recesses 25 and extend radially outward from the inner circular rib 22 toward the outer circular rib 23, extends toward the shoe 27 and along an imaginary line passing through the center of the hole 21 of the boss and passing perpendicularly through the sliding contact surface of shoe 27.

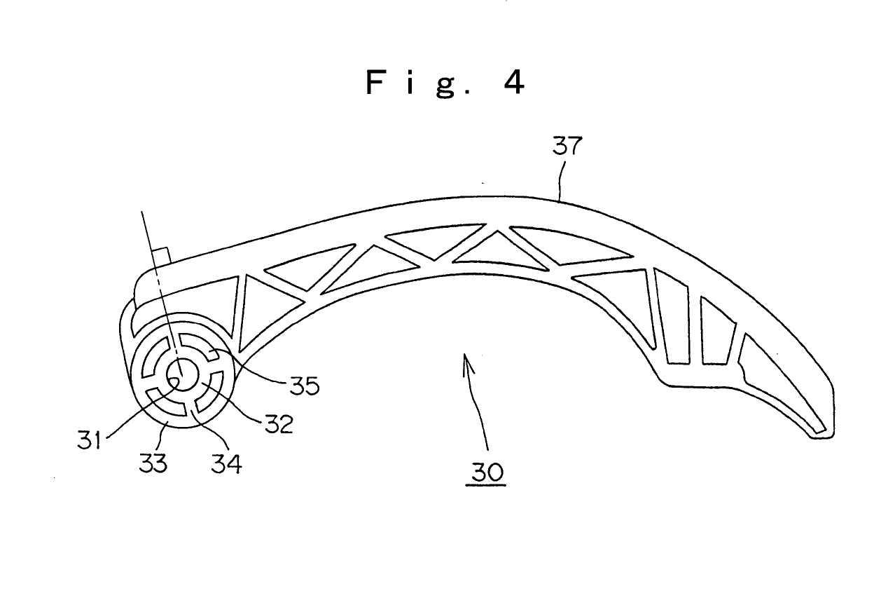

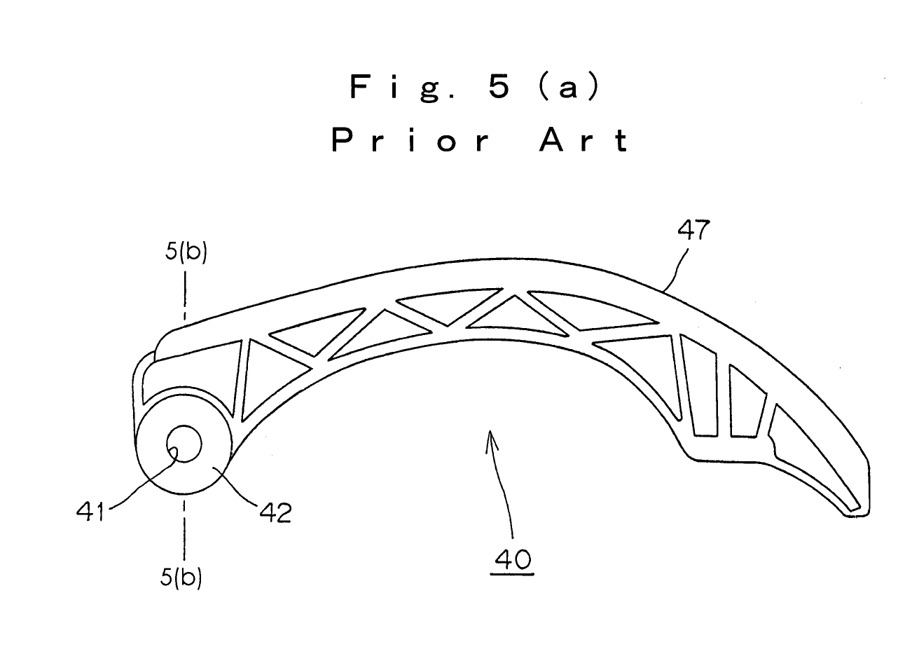

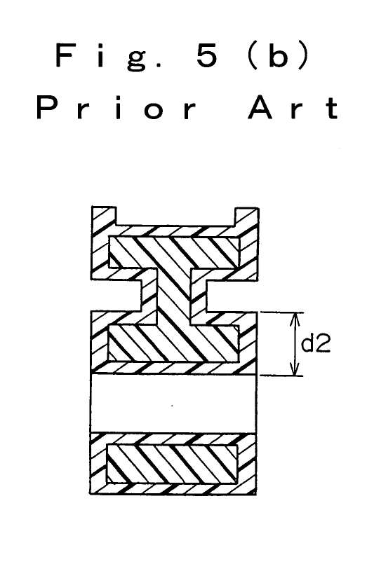

Similarly, in the third embodiment, shown in FIG. 4, one of four connecting ribs 34, which are separated by arcuate recesses 35 and extend radially outward from the inner circular rib 32 toward the outer circular rib 33, extends toward the shoe 37 and along an imaginary line passing through the center of the hole 31 of the boss and passing perpendicularly through the sliding contact surface of shoe 37.

There is no particular limitation on the materials of the core and skin layer in any of the above-described embodiments. However, for superior sliding properties and strength, a polyamide 66 resin is preferably used as the skin layer material and a glass fiber-reinforced polyamide 66 resin is preferably used as the core layer material.

We claim:

1. A movable guide for an endless, flexible, traveling transmission medium, the guide comprising:
a shoe having front and back sides, the front side having a sliding contact surface on which a traveling transmission medium can slide; and
a shoe support provided on the back side of the shoe;
wherein the guide is elongated in a direction along which a transmission medium travels when in sliding contact with said sliding contact surface;
wherein the shoe and shoe support comprise a core and a skin layer composed of different resins, the core and skin layer being sandwich molded;
wherein one end of the guide in the direction of elongation includes a boss for receiving a restraining pin on which the guide is pivotable, and the opposite end of the guide is movable in an arcuate path about an axis of rotation extending through said boss; and
wherein the boss comprises a plurality of concentric circular ribs connected by a plurality of connecting ribs.

2. A movable guide according to claim 1, in which at least one of said plurality of connecting ribs extends in a direction normal to said sliding contact surface of the shoe.

3. A movable guide according to claim 1, in which a resin charging port used in sandwich molding of the guide is provided in an end wall of the mold cavity near the location at which said boss is formed.

4. A movable guide according to claim 3, in which at least one of said plurality of connecting ribs extends toward the shoe and in a direction normal to said sliding contact surface of the shoe.

5. A method for sandwich molding a movable guide for a an endless, flexible, traveling transmission medium which comprises
a shoe having front and back sides, the front side having a sliding contact surface on which a traveling transmission medium can slide; and
a shoe support provided on the back side of the shoe;
wherein the guide is elongated in a direction along which a transmission medium travels when in sliding contact with said sliding contact surface;
wherein the shoe and shoe support comprise a core and a skin layer composed of different resins, the core and skin layer being sandwich molded;
wherein one end of the guide in the direction of elongation includes a boss for receiving a restraining pin on which the guide is pivotable, and the opposite end of the guide is movable in an arcuate path about an axis of rotation extending through said boss; and
wherein the boss comprises a plurality of concentric circular ribs connected by and a plurality of connecting ribs, and is formed at a location adjacent an end wall of a cavity in a mold;
said method comprising the injection of resin into the mold through a resin charging port provided in an end wall of the mold cavity near the location at which said boss is formed.

6. A method according to claim 5, in which at least one of said plurality of connecting ribs is formed so that it extends toward the shoe and in a direction normal to said sliding contact surface of the shoe.
